(19) United States
(12) Patent Application Publication
(10) Pub. No.: US 2002/0122052 A1
(43) Pub. Date: Sep. 5, 2002

(54) Apparatus and method for monitoring the status of a digital cinema system

(76) Inventors: Jason Reich, San Diego, CA (US); Sathiyanarayanan Ramasamy, San Diego, CA (US)

Correspondence Address: Qualcomm Incorporated, Patents Department, 5775 Morehouse Drive, San Diego, CA, 92121-1714, US

(21) Appl. No.: 09/798,505

(22) Filed: Mar. 2, 2001

(51) Int. Cl. G06F 15/00

(52) U.S. Cl. 345/716; 345/772

(57) ABSTRACT

In a digital cinema system comprising a decoder, a theater automation system and an auditorium manager, a method for monitoring playback of a playlist is claimed. An elapsed time and a total time of the playlist are displayed. The theater automation system periodically synchronizes with the decoder to fetch status information from the decoder, which is then displayed.

### BACKGROUND OF THE INVENTION

I. Field of the Invention

The present invention relates to digital cinema. More specifically, the present invention relates to an apparatus and method for monitoring the status of a digital cinema system.

II. Description of the Related Art

In the traditional film industry, theatre operators receive reels of celluloid film from a studio or through a distributor for eventual presentation in a theatre auditorium. The reels of film include the feature program (a full-length motion picture) and a plurality of previews and other promotional material, often referred to as trailers. The theatre operator may also be required or choose to present some its own trailers, often comprising of local promotional and advertising material.

For presentation, a theatre operator builds a “platter”, or playlist. This involves sequencing reels of celluloid film in the order in which it is to be presented, and physically splicing together the film to be played by the projector. In between trailers, or between a trailer and the feature, it is sometimes desirable to display a “black screen”. A black screen is several seconds of blank film, which provides for a transition and somewhat of a dramatic affect between different trailers or features. To create a black screen, the theatre operator physically splices blank film into the desired areas in the same manner as trailers are put together.

A theatre operator also inserts cues and milestones onto celluloid film by physically attaching trigger strips onto the film. Cues may be attached in between programming, or within a particular feature or trailer. Currently, a theatre operator controls auditorium environment through the use of a theatre automation systems. Theatre automation systems control such functions as turning lights on and off, opening and closing curtains, and changing the projector lens. Theatre automation systems control these functions by reading a trigger strip physically placed onto the film as the film passes through a reader connected to the theatre automation system. Trigger strips are typically metallic or optical pieces of tape adhered onto the film. When the tape passes under the reader, an electrical signal is output to the theatre automation system. There are many theatre automation systems available and no uniform way in which theatre automation systems operate. That is, where a trigger strip is placed relative to a frame on the film will cause different theatre automation systems to behave differently. For example, a trigger strip may be placed on a left edge of the film, called an inboard cue, the center of the film, called a center cue, or the right edge of the film, called an outboard cue. Other theatre automation systems interpret only a single trigger strip regardless of where the trigger strip is placed relative to a frame on the film, or mandate in what position the strip must be placed (inboard, center, or outboard) in order to be read. Further still, other theatre automation systems attach meaning to combinations or sequences of trigger strips.

If a theatre operator wants to insert a cue during a presentation of a program, as studios sometimes mandate, the operator must physically look at the frames on the reel of film to determine where the cue should be inserted. Alternatively, the operator may estimate where a trigger strip should be placed by knowing that “x” number of feet of film is equal to about “y” seconds during presentation. For example, a “lights on” cue may be inserted ten seconds after the credits begin. The theatre operator would then physically attach the metallic or optical strip onto the proper place on the film by estimating how many feet of film translates into a ten second delay.

Trailers and features each have associated ratings, which define the appropriateness of the material for a given audience. In the United States, ratings are labeled to motion pictures and trailers by the Motion Picture Association of America (MPAA). However, different jurisdictions have different ratings systems, and not all jurisdictions are consistent as to the rating level of a given program. Accordingly, a theatre operator in a given jurisdiction need be conscious of the types of programs he plans to display together.

Moreover, trailers and features are filmed using a specific display aspect ratio. The display aspect ratio refers to how the image was filmed and how the studio wants the image to be displayed. Typically, images are presented on projectors using either a scope lens or a flat lens. The cinema scope has a ratio of 2.35:1 and a flat lens has a ratio of 1:85:1. The ratio refers to the horizontal plane versus the vertical plane from the size the image is projected onto the screen. Further, various projectors are sensitive to the type of scanning or chroma sampling.

Along with reels of films comprising features and trailers, the theatre operator receives one or more soundtracks to be played with each film. Soundtracks come in a variety of languages and sound formats. Sound formats, such as stereo, 7.1, or 5.1, refer to the number of channels the sound format requires. Because sound systems vary greatly from theatre to theatre, the studio or distributor typically ship multiple soundtracks for a given film.

When a theatre operator is building a platter or playlist, the operator must be careful to ensure that the playlist is created accurately. For example, each image program should have the appropriate soundtrack loaded, in terms of language and sound format. Moreover, the image programs on the platter should have the appropriate ratings. That is, one wants to ensure that an “R” rated trailer is not displayed with a “G” rated movie. Further, cues must be inserted in the proper places and the correct lens needs to be attached to the projector in order for viewing at the proper display aspect ratio. However, human error is inevitable and all too frequent.

Further, an evolution of the film industry is occurring as the industry moves from celluloid film to digitized image and audio programs. Theatres are not equipped to process digital programming to create or monitor “digital platters.”

### SUMMARY OF THE INVENTION

With the advent of Digital Cinema systems, full-length motion pictures, trailers, advertisements and other audio/image “cinema-quality” programs are delivered to theatres throughout the world using digital technology. Digital Cinema systems deliver motion pictures that have been digitized, compressed and encrypted to theatres using either physical media distribution (such as DVD-ROM's) or electronic transmission methods, such as satellite.

Authorized theatres automatically receive the digitized programs and store them, typically while still encrypted and compressed. At each showing, the digitized information is retrieved via a local area network from the storage medium, then is decrypted, decompressed and displayed using cinema-quality electronic projectors featuring high quality digital sound.

Accordingly, an apparatus and method for creating a playlist, or a digital platter, in a digital cinema system is described. Specifically, in a digital cinema system comprising a decoder, a theatre automation system and an auditorium manager, a method for monitoring playback of a playlist is described. An elapsed time and a total time of the playlist are displayed. The theatre automation system periodically synchronizes with the decoder to fetch status information from the decoder, which is then displayed.

Accordingly, it is an aspect of an embodiment to monitor the playback of one or more digital platters.

It is another aspect of an embodiment to minimize network traffic.

It is another aspect of an embodiment to provide periodic updates of platter status.

It is another aspect of an embodiment to provide a mechanism to conveniently and gracefully pause and start presentations.

It is another aspect of an embodiment to provide a qualitative assessment with regards to faults.

It is another aspect of an embodiment to augment and interface with a theatre automation system.

### BRIEF DESCRIPTION OF THE DRAWINGS

The features, objects, and advantages of the invention will become more apparent from the detailed description set forth below when taken in conjunction with the drawings in which like reference characters identify correspondingly throughout and wherein:

FIG. 1 illustrates a block diagram of a digital cinema system;

FIG. 2 illustrates a theatre manager and its associated interfaces; and

FIG. 3 illustrates a status monitor window.

### DETAILED DESCRIPTION OF THE DRAWINGS

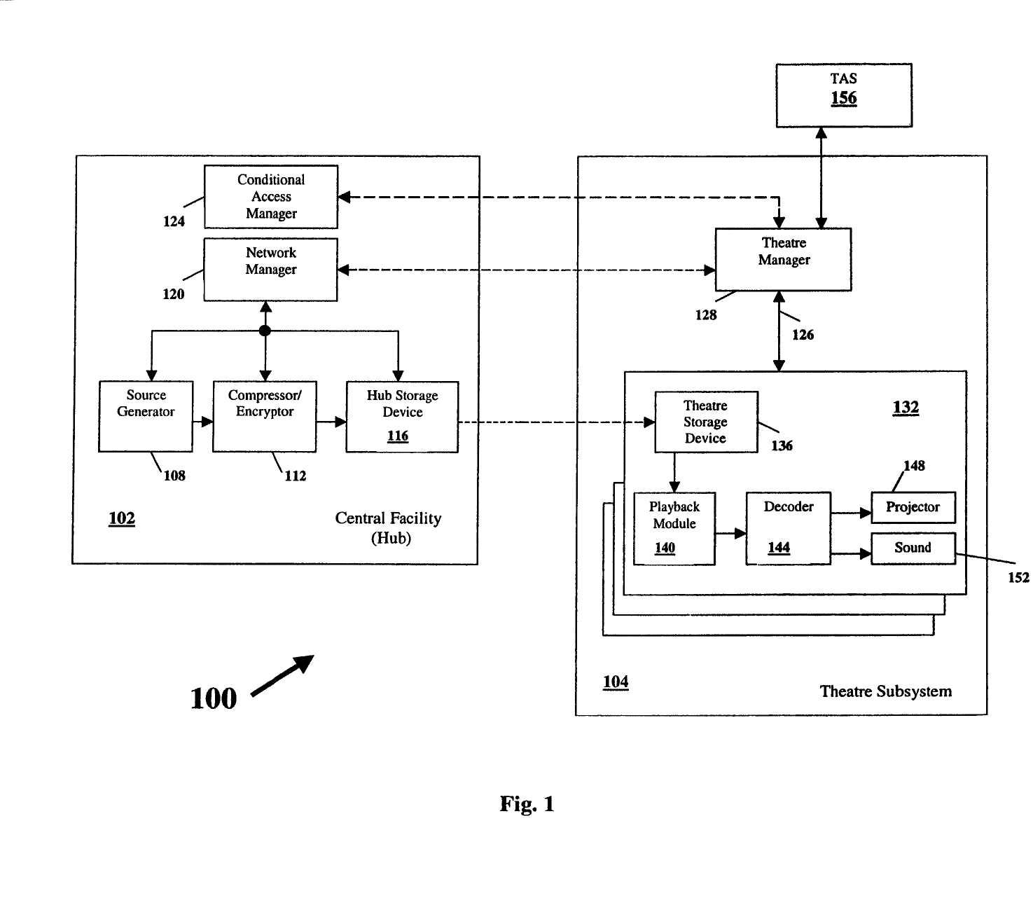

A digital cinema system 100 is illustrated in FIG. 1. The digital cinema system 100 comprises two main systems: at least one central facility or hub 102 and at least one presentation or theatre subsystem 104. The hub 102 and the theatre subsystem 104 are of a similar design to that of pending U.S. patent application Ser. No. 09/075,152 filed on May 8, 1998, entitled, “Apparatus and Method for Distribution of High Quality Image and Audio Programs to Remote Locations,” and pending U.S. patent application Ser. No. 09/564,174, filed May 3, 2000, entitled, “Apparatus and Method for Encoding and Storage of Digital Image and Audio Signals,” and pending U.S. patent application Ser. No. 09/563,880, filed May 3, 2000, entitled, “Apparatus and Method for Decoding Digital Image and Audio Signals,” all assigned to the same assignee as the present invention, and are incorporated by reference herein.

In an embodiment, image and audio information are compressed and stored on a storage medium, and distributed from the hub 102 to the theatre subsystem 104. Generally, one theatre subsystem 104 is utilized for each theatre or presentation location in a network of presentation locations that is to receive image or audio information, and includes some centralized equipment as well as certain equipment employed for each presentation auditorium.

In the central hub 102, a source generator 108 receives film material and generates a digital version of the film. The digital information is compressed and encrypted by a compressor/encryptor (CE) 112, and stored on a storage medium by a hub storage device 116. A network manager 120 monitors and sends control information to the source generator 108, the CE 112, and the hub storage device 116. A conditional access manager 124 provides specific electronic keying information such that only specific theaters are authorized to show specific programs.

In the theatre subsystem 104, a theatre manager 128 controls one or multiple auditorium subsystems 132. The theatre manager 128 controls loading, building a playlist, and controlling and monitoring presentation of image and audio information. The theatre manager may also maintain a history of image and audio programs presented. In an embodiment, each theatre manager may comprise of many auditorium managers, based on the number of auditoriums in a given theatre. In such cases, each auditorium manager controls loading, building a playlist, controlling and monitoring presentation, and maintaining a history of its respective auditorium. Each auditorium manager also interfaces with existing theatre automation systems (TAS) 156 for control of environmental functions.

Based on control information received from the theatre manager 128, a theatre storage device 136 transfers compressed information stored on the storage medium to a playback module 140. The playback module 140 receives the compressed information from the theatre storage device 136, and prepares the compressed information to a predetermined sequence, size and data rate. The playback module 140 outputs the compressed information to a decoder 144. The decoder 144 inputs compressed information from the playback module 140 and performs decryption, decompression and formatting, and outputs the image and audio information to a projector 148 and a sound module 152. The projector 148 plays the image information and the sound module 152 plays sound information on a sound system, both under control of the theatre manager 128.

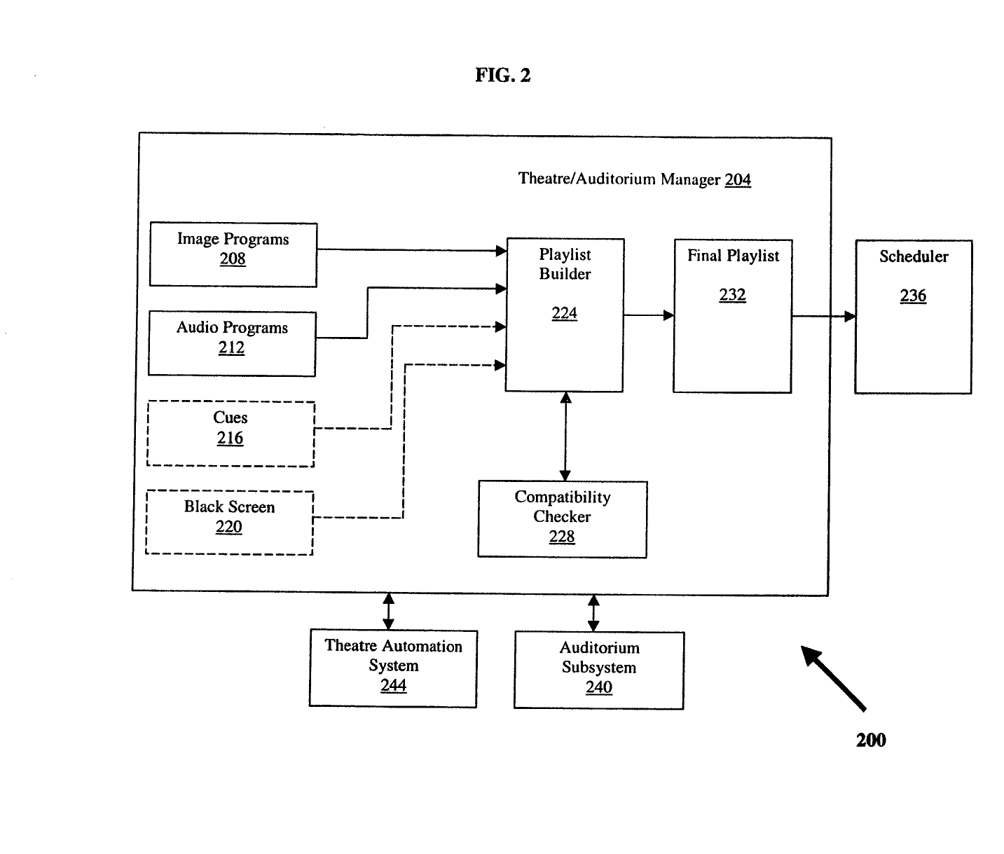

FIG. 2 illustrates a block diagram 200 of the theatre or auditorium manager 204 and its interfaces. The auditorium manager 204 comprises of lists or databases of image programs 208 and audio programs 212. The auditorium manager may also comprise user definable or lists of cues 216 and black screens 220. A playlist builder 224 is configured to allow a user to build a playlist. The playlist builder 224 is configured to interface with a compatibility checker 228 to avoid mismatching. Upon successful compatibility, a final playlist 232 is created. The final playlist is configured to interface with a scheduler 236, which is configured to schedule final playlist 232 for presentation in a designated auditorium at a designated time. Upon playback through an auditorium subsystem 240, the auditorium manager 204 interfaces with an existing theatre automation system 244 as necessary for environmental control.

Loading and creating digital platters are described extensively in pending U.S. patent application Ser. No. unknown, filed Mar. 2, 2001, entitled, “Apparatus and Method for Loading Media in a Digital Cinema System,”, Attorney Docket No. 010214, and U.S. patent application Ser. No. unknown, filed Mar. 2, 2001, entitled “Apparatus and Method of Building a Playlist” Attorney Docket No. 010212, assigned to the same assignee as the present invention, and are incorporated by reference herein.

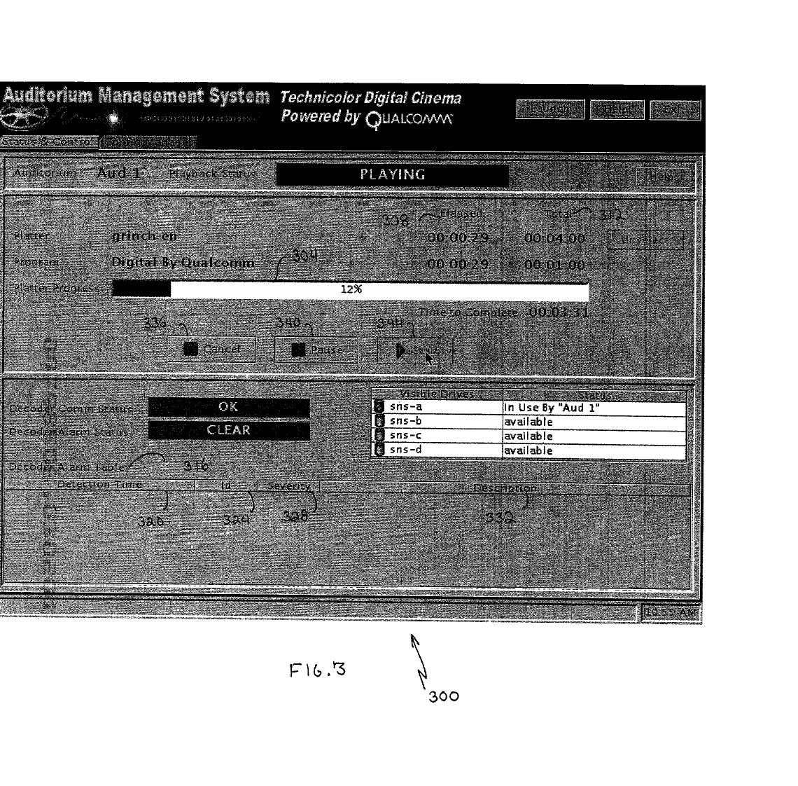

FIG. 3 illustrates a display of a status window 300. After a platter is created and finished, and the files in the given platter are being presented in an auditorium, the user may observe the status of the display using the status screen 300. The status screen 300 comprises, among other features, a platter progress bar 304 that indicates where a platter is during a given play. The status screen also comprises an elapsed time field 308 and a total time field 312. The elapsed time field 312 indicates how far a platter is into a given play, and the total time field 312 indicates the amount of time the given program and the given platter is scheduled to be played.

In an embodiment, the elapsed time field receives periodic status updates over an internal network in a given auditorium. In an embodiment, synchronization the decoder is periodic, but configurable by the user. Thus, although the user sees a continuous clock ticking second by second, the software and hardware involved actually emulates the status in between its periodic playback progress updates. This is advantageous in that overall network traffic is reduced, giving the user the appearance of real-time updates.

The status screen 300 also comprises a decoder alarm table 316. The decoder alarm table 316 comprises fields such as detection time 320, an identifier field 324, a severity field 328, and a description field 332. If an alarm is detected during playback in a given auditorium, information regarding the alarm is transferred to the status and control screen 300 and gives the user further details regarding the particular alarm. The severity field 328 indicates the severity of the given fault. Qualitative judgments regarding types of faults are predetermined and stored. Thus, depending upon the severity of the fault, the user may be interrupted. In an embodiment, whether interruption is warranted for a given fault is configurable. In another embodiment, the severity fields comprise minor, major, and critical. In such cases, the periodic updating is interrupted to give the user an immediate alarm status.

Another aspect of an embodiment to provide a mechanism to conveniently and gracefully pause and start presentations. Cancel button 336, pause button 340, and start button 344 allow for such a mechanism. A user can control playback of the decoder, and control the theatre automation system in a high-level and convenient manner.

As used herein, image programs comprise encoded image information, and may comprise a number of image files. Similarly, audio programs comprise encoded audio information, and soundtracks and may comprise a number of audio files. Accordingly, it is recognized that image programs and audio programs may be combined or subdivided into groups of encoded data in any number of manageable image files and audio files.

As examples, the various illustrative logical blocks, flowcharts, windows, and steps described in connection with the embodiments disclosed herein may be implemented or performed in hardware or software with an application-specific integrated circuit (ASIC), a programmable logic device, discrete gate or transistor logic, discrete hardware components, such as, e.g., registers and FIFO, a processor executing a set of firmware instructions, any conventional programmable software and a processor, or any combination thereof. The processor may advantageously be a microprocessor, but in the alternative, the processor may be any conventional processor, controller, microcontroller, or state machine. The software could reside in RAM memory, flash memory, ROM memory, registers, hard disk, a removable disk, a CD-ROM, a DVD-ROM or any other form of storage medium known in the art.

The previous description of the preferred embodiments is provided to enable any person skilled in the art to make or use the present invention. The various modifications to these embodiments will be ready apparent to those skilled in the art, and the generic principles to find herein may be applied to other embodiments without the use of inventive faculty. Thus, the present invention is not intended to be limited to the embodiments shown herein but is to be accorded the widest scope consistent with the principles and novel features disclosed herein.

What we claim as our invention is:

1. In a digital cinema system comprising a decoder, an theatre automation system and an auditorium manager, a method for monitoring playback of a playlist, the method comprising:
displaying an elapsed time and a total time of the playlist; and
periodically synchronizing with the decoder to fetch status information from the decoder; and
displaying the status information.

2. The method as set forth in claim 1, further comprising:
responsive to an alarm signal, interrupting periodic fetching; and
immediately reporting a severity status level regarding the alarm signal.

3. The method as set forth in claim 2, wherein the severity status level is from the group consisting of: minor, major, and critical.

4. The method as set forth in claim 1, further comprising:
monitoring operation of the theatre automation system.

5. The method as set forth in claim 1, further comprising:
monitoring status of more than one playlist.

6. In a digital cinema system comprising a decoder, an theatre automation system and an auditorium manager, an apparatus for monitoring playback of a playlist, the apparatus comprising:
means for displaying an elapsed time and a total time of the playlist; and
means for periodically synchronizing with the decoder to fetch status information from the decoder; and
means for displaying the status information.

7. The method as set forth in claim 6, further comprising:
responsive to an alarm signal, means for interrupting periodic fetching; and
means for immediately reporting a severity status level regarding the alarm signal.

8. The apparatus as set forth in claim 7, wherein the severity level is from the group consisting of: minor, major, and critical once.

9. A computer readable medium containing instructions for controlling a computer system to perform a method, the method comprising:
displaying an elapsed time and a total time of the playlist; and
periodically synchronizing with the decoder to fetch status information from the decoder; and
displaying the status information.

10. A computer program product comprising:
a computer usable medium having computer readable code embodied therein for creating a playlist, the computer usable medium comprising:
means for displaying an elapsed time and a total time of the playlist; and
means for periodically synchronizing with the decoder to fetch status information from the decoder; and
means for displaying the status information.

11. The product as set forth in claim 10, further comprising:
means for linking the specified audio program to the specified image program to form a selected program, and
means for sequencing the selected programs in the order which presentation is desired.

12. The product as set forth in claim 11, further comprising:
responsive to an alarm signal, means for interrupting periodic fetching; and
means for immediately reporting a severity status level regarding the alarm signal.

13. The product as set forth in claim 12, wherein the severity level is from the group consisting of: minor, major, and critical once.
